(19) United States
(12) Patent Application Publication
(10) Pub. No.: US 2013/0328802 A1
(43) Pub. Date: Dec. 12, 2013

(54) Method for operating functions of a vehicle and corresponding device

(71) Applicant: GM GLOBAL TECHNOLOGY OPERATIONS LLC, Detroit, MI (US)

(72) Inventor: Michael SCHREIBER, Frankfurt (DE)

(73) Assignee: GM GLOBAL TECHNOLOGY OPERATIONS LLC, Detroit, MI (US)

(21) Appl. No.: 13/828,957

(22) Filed: Mar. 14, 2013

(30) Foreign Application Priority Data
Jun. 6, 2012 (DE) 102012011177.0

(51) Int. Cl. G06F 3/0488

(52) U.S. Cl. CPC G06F 3/0488
USPC 345/173

(57) ABSTRACT

The present disclosure relates to a method for operating functions of a vehicle, in particular of a motor vehicle, by means of an operating element. The operating element comprises a touch-sensitive operating surface, wherein via the operating surface a plurality of functions can be operated, and the respective functions are each assigned part regions of the operating surface. The position of the hand of the operator is determined and the respective position of the respective part regions is assigned relative to the position of the hand of the operator. Furthermore, the present disclosure relates to a corresponding device.

### CROSS-REFERENCE TO RELATED APPLICATION

This application claims priority to German Patent Application No. 10 2012 011 177.0, filed June 6, 2012, which is incorporated herein by reference in its entirety.

### TECHNICAL FIELD

The technical field relates to a method for operating functions of a vehicle, in particular of a motor vehicle, by means of an operating element which comprises a touch-sensitive operating surface, wherein via the operating surface a plurality of functions can be operated, wherein the respective functions are each assigned part regions of the operating surface. The technical field furthermore relates to a corresponding device.

### BACKGROUND

Methods and devices of the type mentioned at the outset are known in the prior art. For operating functions of a vehicle, in particular motor vehicle, a number of different operating elements are usual, in particular levers, switches, push buttons and the like. To operate multi-media functions, for example radios, music playback devices or further motor vehicle functions such as navigation systems, air-conditioning settings, other motor vehicle settings and the like, turn and press controller, joysticks and touch-sensitive screens are additionally known.

From DE 10 2005 056 458 A1 it is known to superimpose a video image of hand of a user which is situated at the location of a central operating element with an operating display. By means of this, a direct operation similar to a touch screen operation by the user is visually permitted. The actual operation however is carried out offset on a touch pad. The hand operating the touch pad is detected by means of a digital video camera and subsequently the hand is separated from a background in a detected video image and superimposed on the operating display.

In DE 10 2009 057 739 an operating device for a vehicle having an operating element is additionally disclosed, which comprises an operating surface and a detecting device, with which a location of a finger of a user on the operating surface can be detected, in which with the detecting device a pressure with which the finger presses on the operating surface can also be detected and the detected location and the detected pressure can be provided by the detecting device and an image corresponding to the detected location and the detected pressure can be displayed on a display unit that is separated from the operating element and the detecting device.

However, the operation of corresponding devices requires a comparatively high degree of attention.

In addition, other objects, desirable features and characteristics will become apparent from the subsequent summary and detailed description, and the appended claims, taken in conjunction with the accompanying drawings and this background.

### SUMMARY

Accordingly, the present disclosure provides a method for operating functions of a vehicle, in particular motor vehicle and a corresponding device which can be operated with less attention and more intuitively.

The method according to the present disclosure for operating functions of a vehicle, in particular of a motor vehicle, is carried out by means of an operating element, which comprises a touch-sensitive operating surface. Such a touch-sensitive operating surface in particular is a surface extended in two dimensions, which can be divided into a plurality of part regions.

According to the present disclosure, a plurality of functions can be operated via the operating surface. The respective functions are each assigned part regions of the operating surface. The part regions thus correspond to conventional operating elements. When, by means of the method according to the present disclosure, for example multimedia functions of a motor vehicle are operated, for example volume (loud/soft), title jump (forward/backwards) can be simultaneously offered for operation by means of the operating surface. In a configuration, in which a vehicle air-conditioning can be operated, temperature and ventilation can be adjustable. It is also conceivable that a corresponding function makes possible the change into another menu level. In this way, the complete vehicle control, which is possible with known turn and press controllers or touch-sensitive displays can be displayed with the method according to the present disclosure.

According to the present disclosure it is provided, furthermore, that the position of a hand of the operator is determined and the respective position of the respective part regions is signed relative to the position of the hand of the operator. Determining the position of the hand can for example be carried out through a camera directed at the operating surface or through sensors. Thus, within the scope of the present disclosure, each of the part regions are not assigned fixed positions on the operating surface but variable ones on the operating surface, but which are each aligned in a fixed manner with respect to the position of the hand of the user. It is thereby achieved that no matter how the user positions the hand relative to the operating surface, the part surfaces are always in the same place. Intuitive operation of the vehicle is thus possible.

According to one embodiment of the present disclosure, the position of the hand is determined with the help of the touch-sensitive operating surface. This is possible if the operating surface is designed in order to detect a plurality of touches in different locations on the operating surface at the same time. Within the scope of this further development, the provision of external cameras or sensors for detecting the position of the hand can be omitted.

According to one embodiment of the present disclosure, the position of the hand of the user can be determined by means of the position of the ball of the thumb. In particular, this can take place with the help of the operating surface itself, on which the operator can rest the ball of the thumb. This further development makes possible a comfortable operation since the user need not hold the hand suspended over the operating field but put it down.

According to one embodiment of the present disclosure, the alignment of the hand or of the ball of the thumb of the operator can be determined In this way, the positioning of the part surfaces on the operating surface can be more accurately adapted to the attitude and relative position of the hand of the operator.

According to one embodiment of the present disclosure, the operable functions can be displayed on a display. In this way, the operation of a plurality of operating levels is simplified and the operation becomes more intuitive. The display can either be connected to the operating surface or be formed separately. A separate formation can be realized in the form of a view-favorably arranged display. In the case of a motor vehicle, such a display can for example be arranged in the instrument panel. A further possibility is the use of a projection device, which projects into a windshield (head-up display).

In addition to pressing actuations of the operating surface, other modes of actuation are also conceivable, for example linearly or circularly stroking actuations, as a result of which the scope of operation is increased. This can be correspondingly displayed on the display.

According to one embodiment of the present disclosure the display can take place only when a resting of the ball of the thumb of the operator on the operating surface is determined This prevents a possible distraction of the operator, in particular of the driver of a vehicle, in which the method according to the present disclosure is realized.

According to one embodiment of the present disclosure it can be provided that for assigning the position of the part regions, calibration data are co-used. Such calibration data can be won from a calibration operation, in which the individual operating hand ergonomics are determined This includes for example the size or the hand and/or the length of the fingers as well as of the thumb.

The calibration data can be coupled to a detection of the respective user. The vehicle key or seat and other vehicle settings used can for example be employed for this purpose.

Without calibration, part regions which if applicable extend wedge-like from the contact region of the ball of the thumb to the outside can be used. Since these part regions can also overlap, the detection accuracy under certain conditions can be lower than the detection accuracy with calibration.

According to one embodiment of the present disclosure the operating surface can assign between two and five, in particular five part regions for a corresponding number of functions. Thus, maximally or exactly one part region is assigned for each finger or thumb. The operation is thereby simplified since the fingers need not be repositioned.

According to one embodiment of the present disclosure, the part regions can be arranged within a parallelogram, triangle or trapezium. Such an arrangement reflects the ergonomical circumstances of hands.

The size of parallelogram, triangle or trapezium can be determined through calibration.

According to one embodiment of the present disclosure the position of the part regions can be displayed on the display. Although the operator would not have to look onto the operating surface directly for operating, he can get a secure sense with the display of the position of the part regions to actuate the respective desired function.

According to one embodiment of the present disclosure, a representation of a hand relative to the part regions can be displayed on the display. This facilitates the user's orientation, he can move quickly perceive which function is assigned to which finger.

A first independent subject of the present disclosure relates to a device for operating functions of a vehicle, in particular of a motor vehicle, having an operating element with a touch-sensitive operating surface, via which a plurality of functions can be operated, wherein the respective functions can each be assigned part regions of the operating surface.

The device according to the present disclosure is designed in order to carry out the method described before, it can be used in particular to determine the position of a hand of the operator and the respective position of the respective part regions can be assigned relative to the position of the hand of the operator.

According to one embodiment of the present disclosure it can be provided that the operating element is designed for the simultaneous detection of a plurality of touches in different positions on the operating surface.

According to one embodiment of the present disclosure, the operating element can comprise a display on which the operating surface is arranged.

A further independent subject of the present disclosure relates to a device for operating functions of a vehicle, in particular of a motor vehicle, having an operating element which comprises a touch-sensitive operating surface, wherein via the operating surface a plurality of functions can be operated, wherein part regions of the operating surface can be assigned to each of the respective functions. Here, means for determining the position of a hand of the user and means for assigning the respective position of the respective part regions relative to the position of the hand of the user are provided.

According to one embodiment of the present disclosure, the means for determining the position of the hand of the user can be the touch-sensitive operating surface.

According to one embodiment of the present disclosure, means for determining the position of the hand of the operator by means of the position of the ball of the thumb can be provided.

According to one embodiment of the present disclosure, means for determining the alignment of the hand or of the ball of the thumb of the operator can be provided.

According to one embodiment of the present disclosure, means for calibration can be provided, with the help of which calibration data can be generated, which can be co-used for assigning the position of the part regions.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a motor vehicle having a device for operating the motor vehicle according to the present disclosure;

FIG. 2 is an operating surface of the device according to the present disclosure;

FIG. 3 is a display of the device according to the present disclosure; and

FIG. 4 is an operating surface of the device according to the present disclosure during the calibration.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

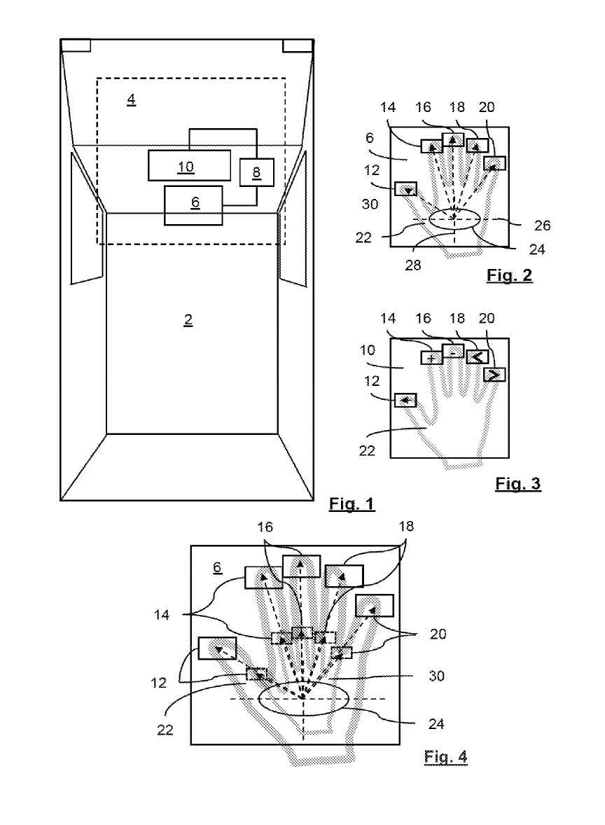

FIG. 1 schematically shows a motor vehicle 2 with a device 4 according to the present disclosure for operating the motor vehicle 2. The components of the device 4 are framed in interrupted lines.

The device 4 comprises an operating surface 6. The operating surface 6 is a touch-sensitive surface which detects pressure exerted on it by the hand (finger, ball of the thumb) and the location in which the pressure is exerted.

Furthermore, the operating surface 6 is able to detect a plurality of touches with a hand occurring in different locations simultaneously. From the applied pressure pattern, pressure contours are generally determined initially and from these the position of the hand (ball of thumb/fingers). In different embodiments, the operating surface 6 can have a display located underneath or not.

To this end, the operating surface 6 can work according to known principles, in particular capacitively, resistively or optically or with mixed forms thereof

The operating surface 6 is connected to a control 8 in a signal-conducting manner. The control 8 interprets the signals of the operating surface 6 and from these derives control commands for the motor vehicle control. The control 8 can be part of a primary motor vehicle control or can be formed separately. In the latter case, the control 8 can be connected to the motor vehicle control in a signal conducting manner.

A display 10 is furthermore connected to the control 8. Instead of the direct connection between control 8 and display 10 shown here, an indirect connection can also be provided, for example via a motor vehicle control.

The display 10 serves to display the functions which can be controlled with the device 4 according to the present disclosure at the time of the display. In addition to this, further information can be displayed on the display 10, e.g. with respect to a motor vehicle navigation, time, outside temperature and/or vehicle-specific displays.

FIG. 2 shows an operating surface 6 of the device 4 according to the present disclosure.

The operating surface 6 is divided into a plurality of part regions 12 to 20. Information regarding a pressure on one of these part regions 12 to 20 detected by the operating surface 6 are transmitted from the operating surface 6 to the control 8, which converts this information into an operating command.

The position of the part regions 12 to 20 is defined by the device 4 according to the present disclosure as a function of the position of a hand 22. The part regions 12 to 20 are distributed over the operating surface in such a manner that each part surface corresponds to a thumb (part region 12) or a finger (part regions 14 to 20).

For determining the absolute position of the fingers of the hand 22, the device 4 determines the position and alignment of a support area 24 of a ball of the thumb of the hand 22, which is placed on the operating surface 6. The support area 24 of a ball of a thumb has a characteristic size and shape which can be determined by the user surface 6. Here, the support area 24 is represented simplified as an ellipse.

By way of the position of the ellipse 24 relative to the operating surface 6, which can be relatively easily determined by computation by way of the position and alignment of a half-axis 26 and a small half-axis 28, the part regions over which the fingers of the hand 22 are located is derived by the device 4. Thus, the device 4 can assign the position of the respective part regions 12 to 20 on the operating surface 6. This can be carried out vectorially as shown. The origin in the present exemplary embodiment is arranged in an intersection of the two half axes 26, 28.

For defining the position of the part regions 12 to 20, additional calibration data are utilized, via which the vectors, as in the present case, can be defined for the individual part regions 12 to 20. The calibration method is explained in more detail in connection with FIG. 4.

FIG. 3 shows the display 10 of the device 4 according to the present disclosure. In the shown example, the device 4 is currently used for operating audio functions.

In the shown configuration, the adjustment of the volume and title jumps are simultaneously possible. With the part region 14, which can be operated with the index finger, it is possible to increase the volume, with the part region 16, which can be operated with the middle finger, it can be reduced. The part region 18 assigned to the ring finger allows a title jump backwards, part region 20 results in a jump to the next title through pressing the operating surface 4. Pressure on part region 12, which can be exerted with the thumb, causes a jump back into a superior menu level.

In the display 10, a representation of the hand 22 of the user is faded in in addition to a representation of the part regions 12 to 20. The user will thus know which finger has to be used for a specific function.

FIG. 4 shows the operating surface 6 of the device according to the present disclosure during the calibration.

A large hand 22 and a small hand 30 are shown. The range of the large hand 22 is much greater than that of the small hand 30. According to the method according to the present disclosure, the part regions 12 to 20 are to be arranged so that they can be operated from the small hand 30 just like by the large hand 22. This requires that the part regions 12 to 20 the small hand 30 have to be arranged substantially nearer to the support area 24 of the palms of the hands 22, 30.

During the calibration, the respective user can be requested to press the respective fingers in succession on the operating surface 6. The device 2 can thereby individually determine vectors starting out from a specific point of the hand contact region 24 for each operator and each finger.

Alternatively, it can be provided that the respective user presses his hand as a whole onto the operating surface 6 so that the device 2 determines the different pressure regions and from this can determine the extents of the respective hand 22, 30.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for operating functions of a vehicle, comprising:
providing an operating element, which comprises a touch-sensitive operating surface;
wherein operating via the operating surface a plurality of functions, wherein the respective functions are each assigned part regions of the operating surface;
determining a position of a hand of the operator; and
assigning the respective position of the respective part regions relative to the position of the hand of the operator.

2. The method according to claim 1, wherein the position of the hand is determined with the help of the touch-sensitive operating surface.

3. The method according to claim 1, wherein the position of the hand of the operator is determined by means of the position of the ball of the thumb of the hand .

4. The method according to claim 3, wherein the alignment of the hand or of the ball of the thumb of the operator is determined.

5. The method according to claim 1, wherein the operable functions are represented on a display.

6. The method according to claim 5, wherein a display takes place only when a contact of the ball of the thumb of the operator is determined on the operating surface.

7. The method according to claim 1, wherein for assigning the position of the part regions, calibration data are used.

8. The method according to claims 1, wherein the operating surface assigns between two and five part regions for a corresponding number of functions.

9. The method according to claims 8, wherein the part regions are arranged within a parallelogram, triangle or trapezium.

10. The method according to claims 9, wherein the position of the part regions is displayed on the display.

11. The method according to claim 10, wherein a representation of a hand relative to the part regions is displayed on the display.

12. A device for operating functions of a vehicle, comprising:
an operating element with a touch-sensitive operating surface, via which a plurality of functions are operated,
wherein the respective functions are assigned part regions of the operating surface.

13. The device according to claim 12, wherein the operating surface is formed for the simultaneous detection of a plurality of touches in different positions.

14. The device according to claim 12, wherein the operating element comprises a display which is arranged on the operating surface.
